(19) United States
(12) Patent Application Publication
(10) Pub. No.: US 2020/0013336 A1
(43) Pub. Date: Jan. 9, 2020

(54) PIXEL CIRCUIT

(71) Applicant: Chunghwa Picture Tubes, LTD., Taoyuan City (TW)

(72) Inventors: Shang-Jung Yang, Taichung City (TW); Chin-Hai Huang, Taoyuan City (TW); Ya-Ju Lu, New Taipei City (TW); En-Chih Liu, Taoyuan City (TW)

(73) Assignee: Chunghwa Picture Tubes, LTD., Taoyuan City (TW)

(21) Appl. No.: 16/131,052

(22) Filed: Sep. 14, 2018

(30) Foreign Application Priority Data
Jul. 6, 2018 (CN) 201810734775.X

(51) Int. Cl. G09G 3/3258; G09G 3/3266; G09G 3/3291

(52) U.S. Cl. CPC G09G 3/3258; G09G 3/3266; G09G 3/3291; G09G 2300/043; G09G 2300/0809; G09G 2310/0264; G09G 2300/0439

(57) ABSTRACT

A pixel circuit is provided. In the pixel circuit, a first transistor has a first terminal coupled to a first node and a second terminal receiving a system high voltage, and the first transistor is controlled by a light emitting signal. A first terminal and a second terminal of a second transistor are respectively coupled to a second node and the first node; a control terminal of the second transistor is coupled to a third node. The third transistor is coupled between the first node and the third node and controlled by a first scan signal. A capacitor has a first terminal and a second terminal. A voltage setting circuit receives a data signal, a second scan signal, and a third scan signal. A first terminal of the light emitting device is coupled to the second node; a second terminal of the light emitting device receives a system low voltage.

### CROSS-REFERENCE TO RELATED APPLICATION

This application claims the priority benefit of China application serial no. 201810734775.X, filed on Jul. 6, 2018. The entirety of the above-mentioned patent application is hereby incorporated by reference herein and made a part of this specification.

### BACKGROUND

### Technical Field

The disclosure relates to a display device; more particularly, the disclosure relates to a pixel circuit.

### Description of Related Art

With the advancement of electronic technologies, display devices have become an indispensable tool in people's lives. In order to provide a good human-machine interface, a high-quality display panel has become a necessary device in a display device.

According to the related art, a display image displayed on the display panel is susceptible to a threshold voltage of a driver transistor in a pixel circuit, e.g., the driver transistor is subject to long-term operation or process variations, so that the display brightness of a light emitting device (e.g., an organic light emitting diode) is prone to be uneven, which further poses a negative impact on the quality of the display image. Therefore, how to lessen the impact of the threshold voltage on the display image will be an important issue for those skilled in the pertinent art.

### SUMMARY

The disclosure provides a pixel circuit capable of solving an issue of an offset of the threshold voltage due to the process variations and long-term operation of transistors through controlling operational correlations of the transistors and through timing control of each scan signal, and the quality of the display image may be further improved.

In an embodiment, a pixel circuit includes a first transistor, a second transistor, a third transistor, a capacitor, a voltage setting circuit, and a light emitting device. The first transistor has a first terminal coupled to a first node, a second terminal receiving a system high voltage, and a control terminal receiving a light emitting signal. The second transistor has a first terminal coupled to a second node, a second terminal coupled to the first node, and a control terminal coupled to a third node. The third transistor has a first terminal coupled to the third node, a second terminal coupled to the first node, and a control terminal receiving a first scan signal. The capacitor has a first terminal and a second terminal coupled to the third node. The voltage setting circuit is coupled between the first terminal of the capacitor and the second node and receives a data signal, a second scan signal, and a third scan signal, wherein the voltage setting circuit includes a fourth transistor and a fifth transistor. The fourth transistor has a first terminal coupled to the first terminal of the capacitor, a second terminal receiving the data signal, and a control terminal receiving the second scan signal. The fifth transistor has a first terminal coupled to the second node, a second terminal coupled to the first terminal of the capacitor, and a control terminal receiving the third scan signal. The light emitting device has a first terminal coupled to the second node and a second terminal receiving a system low voltage.

In view of the above, through controlling the operational correlations of the transistors and through timing control of each scan signal, the pixel circuit provided in one or more exemplary embodiments may solve the issue of the offset of the threshold voltage due to the process variations and long-term operation of the transistors, and the quality of the display image may be further improved.

To make the above features and advantages provided in one or more of the embodiments more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles provided in the disclosure.

FIG. 1 is a circuit diagram of a pixel structure according to an embodiment of the invention.

FIG. 2 is a schematic view illustrating a waveform of a pixel circuit according to an embodiment of the invention.

### DETAILED DESCRIPTION OF EMBODIMENTS

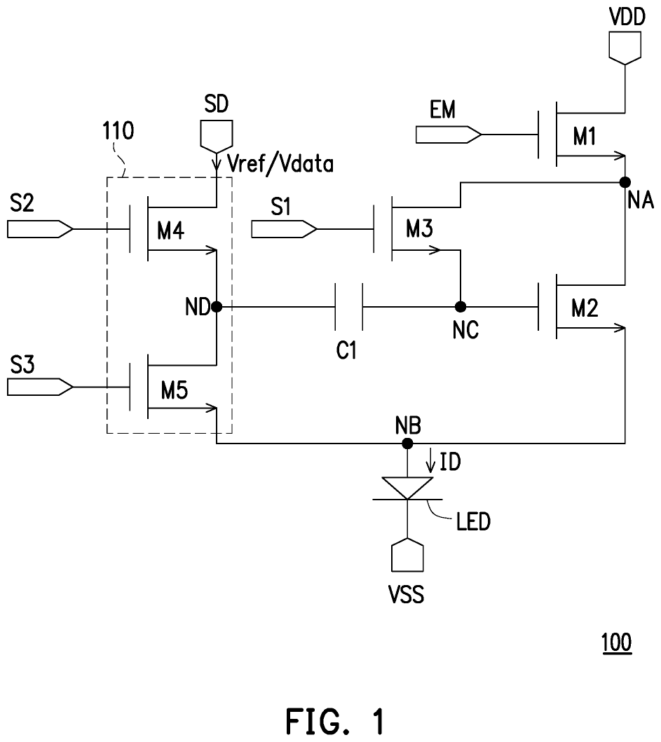

FIG. 1 is a circuit diagram of a pixel structure according to an embodiment of the invention. With reference to FIG. 1, in the present embodiment, a pixel circuit 100 includes a first transistor M1, a second transistor M2, a third transistor M3, a capacitor C1, a voltage setting circuit 110, and a light emitting device LED. The voltage setting circuit 110 is coupled between a first terminal of the capacitor C1 and a node NB and may receive a data signal SD, a second scan signal S2, and a third scan signal S3. Here, the voltage setting circuit 110 may include a fourth transistor M4 and a fifth transistor M5. Note that the first to fifth transistors M1-M5 are n-type transistors, for instance, which should however not be construed as a limitation in the disclosure.

In the present embodiment, the capacitor C1 is coupled between the voltage setting circuit 110 and a node NC and is configured to store data voltage Vdata. An anode of the light emitting device LED (corresponding to a first terminal) is coupled to the node NB, and a cathode of the light emitting device LED (corresponding to a second terminal) receives a system low voltage VSS. Here, the light emitting device LED may correspondingly emit light according to an on-current ID. Note that the light emitting device LED provided in the present embodiment may be one of an organic light emitting diode and a micro light emitting diode, which should however not be construed as a limitation in the disclosure.

In another aspect, according to the present embodiment, the first transistor M1 has a source (corresponding to a first terminal) coupled to a node NA, a drain (corresponding to a second terminal) capable of receiving a system high voltage VDD, and a gate (corresponding to a control terminal) capable of receiving a light emitting signal EM. Here, the first transistor M1 may determine whether the system high voltage VDD and the pixel circuit 100 should be disconnected according to the state of the light emitting signal EM, so as to ensure the normal operation of the pixel circuit 100. The second transistor M2 has a source (corresponding to a first terminal) coupled to the node NB, a drain (corresponding to a second terminal) coupled to the node NA, and a gate (corresponding to a control terminal) coupled to the node NC. Here, the second transistor M2 may be configured to drive the light emitting device LED, and a driving capability of the second transistor M2 may be correlated to a length-width ratio of the second transistor M2 (e.g., the length-width ratio of the second transistor M2 may be designed to be larger than a length-width ratio of the first transistor M1 and length-width ratios of the third to fifth transistors M3-M5, which should however not be construed as a limitation in the disclosure).

Next, the third transistor M3 has a source (corresponding to a first terminal) coupled to the node NC, a drain (corresponding to a second terminal) coupled to the node NA, and a gate (corresponding to a control terminal) capable of receiving a first scan signal S1. Here, the third transistor M3 may determine whether a diode connection should exist between the second transistor M2 and the third transistor M3 according to the state of the first scan signal S1.

In another aspect, in the voltage setting circuit 110 provided in the present embodiment, the fourth transistor M4 has a source (corresponding to a first terminal) coupled to a node ND, a drain (corresponding to a second terminal) capable of receiving the data signal SD, and a gate (corresponding to a control terminal) capable of receiving the second scan signal S2. Here, the fourth transistor M4 may, according to the state of the second scan signal S2, determine whether to transmit the data signal SD to the pixel circuit 100. The fifth transistor M5 has a source (corresponding to a first terminal) coupled to the node NB, a drain (corresponding to a second terminal) coupled to the node ND, and a gate (corresponding to a control terminal) capable of receiving the third scan signal S3. Here, the fifth transistor M5 may, according to the state of the third scan signal S3, determine whether to reset the voltage stored in the capacitor C1 in advance.

According to the present embodiment, note that the data signal SD may be a reference voltage Vref or a data voltage Vdata. For instance, when the data signal SD is set as the reference voltage Vref at a low voltage level, the voltage setting circuit 110 may eliminate charges from the capacitor C1 according to the reference voltage Vref, the second scan signal S2, and the third scan signal S3. By contrast, when the data signal SD is set as the data voltage Vdata at a high voltage level, the voltage setting circuit 110 may write the data voltage Vdata into the capacitor C1 according to the data voltage Vdata, the second scan signal S2, and the third scan signal S3. Namely, the voltage setting circuit 110 may reset the capacitor C1 or write data into the capacitor C1 according to the data signal SD, the second scan signal S2, and the third scan signal S3.

According to an embodiment of the invention, the first to third scan signals S1-S3 may be transmitted by one of a plurality of gate lines in a display panel (not shown), for instance. Besides, the data signal SD (i.e., the reference voltage Vref and the data voltage Vdata) may be transmitted by one of a plurality of data lines in the display panel (not shown), for instance. In the display panel (not shown), plural pixels are arranged in a matrix and located at intersections of the data lines and the gate lines, and the operation of the pixel circuit (e.g., the pixel circuit 100) is controlled by the corresponding gate lines and data lines.

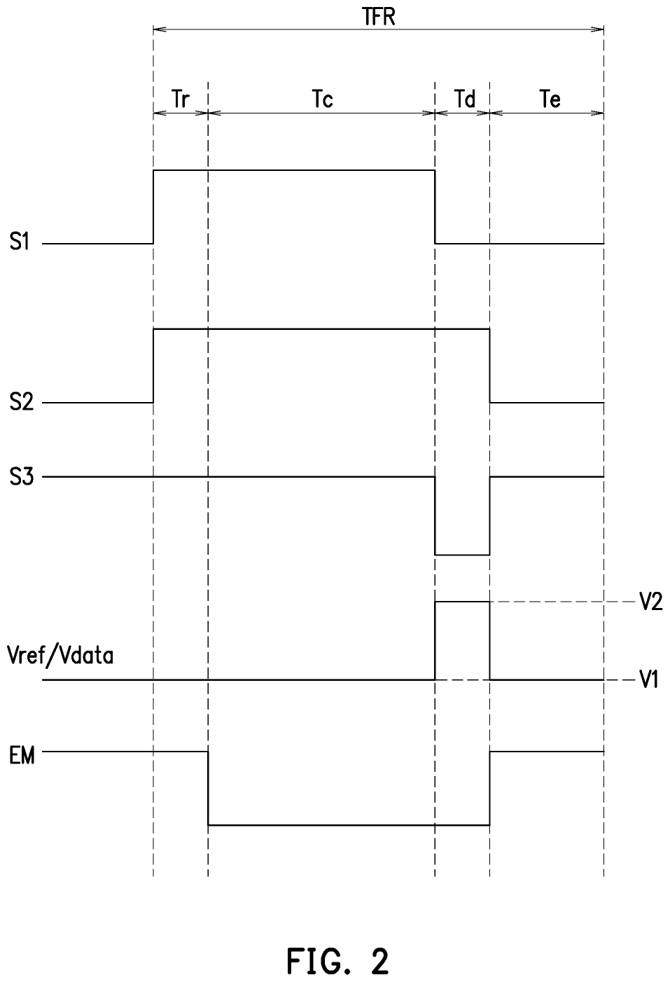

FIG. 2 is a schematic view illustrating a waveform of a pixel circuit according to an embodiment of the invention. With reference to FIG. 2, in the present embodiment, one frame period TFR of the pixel circuit 100 may be divided into a voltage resetting period Tr, a voltage compensation period Tc, a data writing period Td, and a light emitting period Te, and the voltage resetting period Tr, the voltage compensation period Tc, the data writing period Td, and light emitting period Te do not overlap. Here, the voltage compensation period Tc is after the voltage resetting period Tr, the data writing period Td is after the voltage compensation period Tc, and the light emitting period Te is after the data writing period Td. For instance, in the frame period TFR, the voltage resetting period Tr and the voltage compensation period Tc of the pixel circuit 100 may be considered as a period during which the pixel circuit 100 is set; the data writing period Td of the pixel circuit 100 may be considered as a period during which data are written into the pixel circuit 100; the light emitting period Te of the pixel circuit 100 may be considered as a display period of the pixel circuit 100.

The detailed operations of the pixel circuit 100 may be learned from FIG. 1 and FIG. 2. Specifically, in the present embodiment, when the pixel circuit 100 operates in the voltage resetting period Tr, the first to third scan signals S1-S3 and the light emitting signal EM may all be set as being enabled (e.g., at a high voltage level), so as to switch on the first transistor M1 and the third to fifth transistors M3-M5. Besides, the data signal SD may be set as the reference voltage Vref at a low voltage level V. Here, the connection between the second transistor M2 and the third transistor M3 may be the diode connection. Since the first transistor M1, the third transistor M3, and the fourth transistor M4 are in an on state, the voltage value of the first terminal (i.e., the node ND) of the capacitor C1 may be the voltage value of the reference voltage Vref, and the voltage value of the second terminal (i.e., the node NC) of the capacitor C1 may be the voltage value of the system high voltage VDD. Thereby, the pixel circuit 100 may eliminate the charges remaining in the capacitor C1 and reset the voltage value of the capacitor C1. Meanwhile, the voltage value of the gate (i.e., the node NC) of the second transistor M2 is the voltage value of the system high voltage VDD, and therefore the second transistor M2 may also be switched on.

In the voltage resetting period Tr, note that the fifth transistor M5 is in an on state; hence, the reference voltage Vref of the first terminal (i.e., the node ND) of the capacitor C1 may be transmitted to the anode (i.e., the node NB) of the light emitting device LED. Besides, the voltage value of the reference voltage Vref of the anode (i.e., the node NB) of the light emitting device LED is smaller than the sum of the threshold voltage of the light emitting device LED and the voltage value of the system low voltage VSS; hence, the light emitting device LED provided in the present embodiment does not emit light at this stage.

Next, when the pixel circuit 100 operates in the voltage compensation period Tc, the first to third scan signals S1-S3 may be set as being enabled (e.g., at a high voltage level), and the light emitting signal EM may be set as being disabled (e.g., at a low voltage level), so as to switch off the first transistor M1 and switch on the third to fifth transistors M3-M5. Meanwhile, the data signal SD man be continuously set as having the reference voltage Vref at the low voltage level V1.

To be specific, when the pixel circuit 100 operates in the voltage compensation period Tc, a discharging path may be formed by the second to fifth transistors M2-M5 because the connection between the second transistor M2 and the third transistor M3 is the diode connection and the fourth to fifth transistors M4-M5 are both in the on state. In this case, the voltage stored in the capacitor C1 in the previous stage (i.e., in the voltage resetting period Tr) may be discharged through the discharging path, and the voltage stored in the previous stage (i.e., in the voltage resetting period Tr) may be discharged until the voltage value is equal to the value of the threshold voltage of the second transistor M2. Thereby, the threshold voltage of the second transistor M2 may be stored in the capacitor C1. That is, in the voltage compensation period Tc, the pixel circuit 100 may obtain the offset of the threshold voltage by means of the capacitor C1. Note that the offset is caused by the process variations and long-term operation of the second transistor M2.

In the voltage compensation period Tc, note that the voltage value of the first terminal (i.e., the node ND) of the capacitor C1 may continue to be the voltage value of the reference voltage Vref, and the voltage value of the second terminal (i.e., the node NC) of the capacitor C1 may be the sum of the reference voltage Vref and the threshold voltage of the second transistor M2. Note that the fifth transistor M5 is in an on state; hence, the reference voltage Vref of the first terminal (i.e., the node ND) of the capacitor C1 may also be transmitted to the anode (i.e., the node NB) of the light emitting device LED. Besides, the voltage value of the reference voltage Vref of the anode (i.e., the node NB) of the light emitting device LED is smaller than the sum of the threshold voltage of the light emitting device LED and the voltage value of the system low voltage VSS; hence, the light emitting device LED provided in the present embodiment does not emit light at this stage.

On the other hand, in the present embodiment, when the pixel circuit 100 operates in the data writing period Td, the first scan signal S1, the third scan signal S3, and the light emitting signal EM may be set as being disabled (e.g., at a low voltage level), and the second scan signal S2 may be set as being enabled (e.g., at a high voltage level), so as to switch off the first transistor M1, the third transistor M3, and the fifth transistor M5 and switch on the fourth transistor M4. In addition, the data signal SD may be adjusted from the reference voltage Vref at the low voltage level V1 to the data voltage Vdata at the high voltage level V2.

In this case, the data voltage Vdata may be transmitted to the pixel circuit 100. At the same time, the voltage value of the first terminal (i.e., the node ND) of the capacitor C1 may be the voltage value of the data voltage Vdata. Besides, the pixel circuit 100 may, according to the coupling effect of the capacitor C1, adjust the voltage value of the second terminal (i.e., the node NC) of the capacitor C1 to be the sum of the threshold voltage of the second transistor M2 and the difference between the data voltage Vdata and the reference voltage Vref. In other words, in the data writing period Td, the capacitor C1 still stores the threshold voltage of the second transistor M2. Additionally, in the data writing period Td, the second transistor M2 and the fifth transistor M5 are both in an off state, so that the anode (i.e., the node NB) of the light emitting device LED is in a floating state. As such, the light emitting device LED provided in the present embodiment does not emit light in this stage.

On the other hand, when the pixel circuit 100 operates in the light emitting period Te, the first to second scan signals S1-S2 may be set as being disabled (e.g., at a low voltage level), and the third scan signal S3 and the light emitting signal EM may be again set as being enabled (e.g., at a high voltage level), so as to switch on the first transistor M1 and the fifth transistor M5 and switch off the third transistor M3 and the fourth transistor M4. In this case, the data signal SD cannot be transmitted to the pixel circuit 100. In the light emitting period Te, note that the first transistor M1 is in an on state; hence, the system high voltage VDD may be transmitted to the first terminal (i.e., the node NA) of the first transistor M1, which allows the second transistor M2 to operate in a saturation region.

Particularly, in the light emitting period Te, the voltage value of the gate (i.e., the node NC) of the second transistor M2 may be the voltage stored in the previous stage (i.e., in the data writing period Td); namely, the voltage value of the gate (i.e., the node NC) of the second transistor M2 may be the sum of the threshold voltage of the second transistor M2 and the difference between the data voltage Vdata and the reference voltage Vref. Meanwhile, the voltage value of the source (i.e., the node NB) of the second transistor M2 may be the sum of the threshold voltage of the light emitting device LED and the voltage value of the system low voltage VSS.

In light of the foregoing, when the pixel circuit 100 operates in the light emitting period Te, and when the second transistor M2 operates in the saturation region, the second transistor M2 is able to provide an on-current ID to the light emitting device LED, so as to drive the light emitting device LED. At this time, the on-current ID flowing through the light emitting device LED may be expressed as the equation below:

ID=K((Vdata−Vref+Vth)−(VLED+VSS)−Vth)²

Here, ID is the current value of the on-current ID; K is a process parameter of the second transistor M2; Vdata is the voltage value of the data voltage Vdata; Vref is the voltage value of the reference voltage Vref; Vth is the voltage value of the threshold voltage of the second transistor M2; VLED is the voltage value of the threshold voltage of the light emitting device LED; VSS is the voltage value of the system low voltage VSS.

According to the aforesaid equation, it may be learned that when the pixel circuit 100 operates in the light emitting period Te, the pixel circuit 100 is able to solve the issue of the offset of the threshold voltage caused by the process variations or long-term operation of the second transistor M2. Besides, since the second transistor M2 and the fifth transistor M5 are both in an on state, the capacitor C1, the second transistor M2, and the fifth transistor M5 may constitute a conductive path. In this case, the gate (i.e., the node NC) of the second transistor M2 is not in a floating state in the light emitting period Te. In other words, when the threshold voltage of the light emitting device LED is also offset due to the process variations or long-term operation, the pixel circuit 100 may enable the second transistor M2 to synchronously compensate through the conductive path according to the coupling effects of the capacitor C1. Thereby, the pixel circuit provided in the present embodiment is able to effectively solve the issue of the offset of the threshold voltage caused by the process variations or long-term operation of the second transistor M2 and the light emitting device LED, so as to further improve the quality of the display image.

To sum up, the pixel circuit provided in one or more embodiments of the invention may store the threshold voltage for driving the transistor corresponding to the light emitting device according to the coupling effect of the capacitor when the pixel circuit operates in the voltage compensation period. Thereby, when the pixel circuit operates in the light emitting period, the pixel circuit is able to effectively solve the issue of the offset of the threshold voltage caused by the process variations or long-term operation of the transistors, so as to further improve the quality of the display image.

It will be apparent to those skilled in the art that various modifications and variations can be made to the structure provided herein without departing from the scope or spirit of the invention. In view of the foregoing, it is intended that the disclosure provide modifications and variations provided they fall within the scope of the following claims and their equivalents.

What is claimed is:

1. A pixel circuit comprising:
a first transistor having a first terminal coupled to a first node, a second terminal receiving a system high voltage, and a control terminal receiving a light emitting signal;
a second transistor having a first terminal coupled to a second node, a second terminal coupled to the first node, and a control terminal coupled to a third node;
a third transistor having a first terminal coupled to the third node, a second terminal coupled to the first node, and a control terminal receiving a first scan signal;
a capacitor having a first terminal and a second terminal coupled to the third node;
a voltage setting circuit coupled between the first terminal of the capacitor and the second node and receiving a data signal, a second scan signal, and a third scan signal, wherein the voltage setting circuit comprises:
a fourth transistor having a first terminal coupled to the first terminal of the capacitor, a second terminal receiving the data signal, and a control terminal receiving the second scan signal; and
a fifth transistor having a first terminal coupled to the second node, a second terminal coupled to the first terminal of the capacitor, and a control terminal receiving the third scan signal; and
a light emitting device having a first terminal coupled to the second node and a second terminal receiving a system low voltage.

2. The pixel circuit according to claim 1, wherein a frame period during which the pixel circuit is driven comprises a voltage resetting period, a voltage compensation period, a data writing period, and a light emitting period.

3. The pixel circuit according to claim 2, wherein the voltage compensation period is after the voltage resetting period, the data writing period is after the voltage compensation period, and the light emitting period is after the data writing period.

4. The pixel circuit according to claim 2, wherein the first scan signal is enabled in the voltage resetting period and the voltage compensation period, the second scan signal is enabled in the voltage resetting period, the voltage compensation period, and the data writing period, the third scan signal is enabled in the voltage resetting period, the voltage compensation period, and the light emitting period, and the light emitting signal is enabled in the voltage resetting period and the light emitting period.

5. The pixel circuit according to claim 1, wherein the data signal is a reference voltage and a data voltage.

6. The pixel circuit according to claim 2, wherein the light emitting device is stopped from emitting light in the voltage resetting period.

7. The pixel circuit according to claim 2, wherein the capacitor stores a threshold voltage of the second transistor in the voltage compensation period and the data writing period.

8. The pixel circuit according to claim 1, wherein a driving capability of the second transistor is correlated to a length-width ratio of the second transistor.

9. The pixel circuit according to claim 1, wherein the light emitting device comprises one of an organic light emitting diode and a micro light emitting diode.
